(19) United States
(12) Patent Application Publication
(10) Pub. No.: US 2025/0229567 A1
(43) Pub. Date: Jul. 17, 2025

(54) Multipurpose Writing Instrument with Releasable Ruler

(71) Applicant: Eric Young, La Mesa, CA (US)

(72) Inventor: Eric Young, La Mesa, CA (US)

(21) Appl. No.: 19/015,205

(22) Filed: Jan. 9, 2025

Related U.S. Application Data
(60) Provisional application No. 63/620,222, filed on Jan. 12, 2024.

(51) Int. Cl. B43K 29/08; G01B 3/04

(52) U.S. Cl. CPC B43K 29/08; G01B 3/04

(57) ABSTRACT

A multipurpose device that combines a writing instrument and ruler releasably attached thereto. The core components of the invention are the writing instrument and ruler, which, generally speaking, are configured as follows: the writing instrument is an elongated rigid form with a shallow recess in its outer surface. The ruler is an elongated, thin-walled semi-tubular form that is shaped to substantially fill the respective recess within the outer surface of the writing instrument. During normal use, the ruler may be snapped onto and off the writing instrument or may slide onto and off of the writing instrument.

### FIELD OF THE INVENTION

The invention relates generally to a multipurpose writing instrument with releasable ruler.

### BACKGROUND OF THE INVENTION

Currently, there are a number of solutions for combining the functionality of a ruler with that of a writing instrument into a single device. Some of these solutions attempt to provide a design with a ruler that is printed onto the writing instrument itself and therefore cannot be used in conjunction with the writing instrument, such as to draw a straight line. Other solutions attempt to provide a more functional design where the ruler is releasably engaged with the writing instrument in one way or another, but these designs fail to meet the needs of the industry because they are unnecessarily complex, lack ergonomic comfort, are aesthetically displeasing, or a combination of these failures.

### SUMMARY OF THE INVENTION

This section is for the purpose of summarizing the present invention.

It is one object of the present invention to provide a device wherein a ruler is releasably attached to a writing instrument for use in various situations where a ruler may be desired.

It is a further object of the present invention to provide a combined writing instrument and releasably attached ruler, wherein the writing instrument may be conveniently and comfortably utilized without having to first remove the ruler from the writing instrument.

It is a further object of the present invention to provide a device wherein a ruler is securely attached to a writing instrument and effectively resists unintentional disengagement from the writing instrument.

It is a further object of this invention to provide a combined writing instrument and ruler wherein the ergonomic comfort and aesthetic of the writing instrument is not significantly compromised by the attachment or detachment of the ruler.

The above and other objects and advantages of the invention are accomplished with a multipurpose writing implement comprised of a writing instrument element and ruler element, wherein the ruler element releasably engages the writing instrument element. The writing instrument has a body with an outer wall, and the ruler has a body with a longitudinal axis and an inner wall. A recess is formed in the outer wall of the body and configured to accommodate the ruler body, wherein the inner wall of the ruler body substantially corresponds to a shape of the recess and an outer wall of the ruler body is substantially flush with the outer wall of the writing instrument body when the ruler is attached to the writing instrument.

In some embodiments, the ruler body has a cross-section shape selected from circular, elliptical, and polygonal with sharp or rounded corners.

In certain embodiments, a portion of the recess does not accommodate the ruler body when the ruler is attached to the writing instrument, wherein the portion of the recess is configured to accommodate a user's finger to apply force to a portion of the ruler to disengage the ruler from the writing instrument.

In some embodiments, a portion of the recess has a chamfered edge configured to engage a portion of the ruler when a longitudinal force is applied to the ruler relative to the writing instrument to detach the ruler from the writing instrument.

In certain embodiments, the ruler has a first longitudinal edge and a second longitudinal edge, the first and second longitudinal edges extending substantially parallel to the longitudinal axis of the ruler. In some of these embodiments, the first and second longitudinal edges are disposed at an angle of less than 180 degrees about the longitudinal axis relative to one another. In additional embodiments, a linear distance between the first and second longitudinal edges is smaller than a maximum linear distance between two opposing sides of the recess at its widest portion when the ruler is positioned in the recess.

In some embodiments, the ruler body is made with an elastic material configured to deform when pressed onto the body of the writing instrument.

In certain embodiments, the ruler is configured to be attached to the writing instrument body by deformation force alone.

The objects and advantages of the invention are also achieved with a multipurpose writing implement including a writing instrument having a body with an outer wall, and a ruler releasably attached to the writing instrument, the ruler having a body with a longitudinal axis and an inner wall substantially corresponding to a shape of at least a portion of the outer wall of the writing instrument. The ruler body is made with an elastic material configured to deform when pressed onto the body of the writing instrument such that the ruler is attached to the instrument body by deformation force.

In some embodiments, the ruler body has a cross-section shape selected from circular, elliptical, and polygonal with sharp or rounded corners.

In certain embodiments, the ruler has a first longitudinal edge and a second longitudinal edge, the first and second longitudinal edges extending substantially parallel to the longitudinal axis of the ruler and disposed at an angle of less than 180 degrees about the longitudinal axis relative to one another.

In some embodiments, the writing instrument body includes a recess formed in the outer wall of the body and configured to accommodate the ruler body, wherein an outer wall of the ruler body is substantially flush with the outer wall of the writing instrument body when the ruler is attached to the writing instrument.

In certain embodiments, the ruler has a first longitudinal edge and a second longitudinal edge, the first and second longitudinal edges extending substantially parallel to the longitudinal axis of the ruler, and wherein a linear distance between the first and second longitudinal edges is smaller than a maximum linear distance between two opposing sides of the recess at its widest portion when the ruler is positioned in the recess. In additional embodiments, a portion of the recess does not accommodate the ruler body when the ruler is attached to the writing instrument, wherein the portion of the recess is configured to accommodate a user's finger to apply force to a portion of the ruler to disengage the ruler from the writing instrument. In further embodiments, a portion of the recess has a chamfered edge configured to engage a portion of the ruler when a longitudinal force is applied to the ruler relative to the writing instrument to detach the ruler from the writing instrument.

In some embodiments, the ruler is configured to be attached to the writing instrument body by deformation force alone.

Other features and advantages of the present invention will become apparent from the following more detailed description, which illustrates, by way of example, the principle of the invention.

### BRIEF DESCRIPTION OF THE DRAWINGS

FIG. 1 shows a perspective view of an embodiment of a writing instrument/ruler apparatus in an assembled state.

FIG. 2 shows a perspective view of the apparatus of FIG. 1 in an exploded state.

FIG. 3 shows a side plan view of the apparatus of FIG. 1 in an assembled state.

FIG. 4 shows a cross-sectional view along the line 4-4 of the apparatus of FIG. 3.

FIG. 5 shows a cross-sectional view along the line 5-5 of the apparatus of FIG. 4.

FIG. 6 shows a side plan view of the apparatus of FIG. 1 in an exploded state with the ruler being removed from the writing instrument. FIG. 7 shows a cross-sectional view along the line 7-7 of the apparatus of FIG. 6.

FIG. 8 shows a perspective view of the apparatus of FIG. 1 with the ruler completely removed from the writing instrument.

FIG. 9 shows a perspective view of another embodiment of a writing instrument/ruler apparatus in an assembled state.

FIG. 10 shows a perspective view of the apparatus of FIG. 9 in an exploded state.

FIG. 11 shows a side plan view of the apparatus of FIG. 9 in an assembled state.

FIG. 12 shows a partial enlarged view of area 12 of the apparatus of FIG. 11.

FIG. 13 shows a cross-sectional view alone the line 13-13 of the apparatus of FIG. 11.

FIG. 14 shows a side plan view of the apparatus of FIG. 9 in an exploded state with the ruler being removed from the writing instrument.

FIG. 15 shows a cross-sectional view along the line 15-15 of the apparatus of FIG. 14.

FIG. 16 shows a perspective view of the apparatus of FIG. 9 in an exploded state with the ruler completely detached from the writing instrument.

FIG. 17 shows a perspective view of another embodiment of a writing instrument/ruler apparatus in an assembled state.

FIG. 18 shows a perspective view of the apparatus of FIG. 17 in an exploded state.

FIG. 19 shows a side plan view of the apparatus of FIG. 17 in an assembled state.

FIG. 20 shows a cross-sectional view along the line 20-20 of the apparatus of FIG. 19.

FIG. 21 shows a back plan section view 21-21 of the apparatus of FIG. 19.

FIG. 22 shows a cross-sectional view along the line 22-22 of the apparatus of FIG. 21.

FIG. 23 shows a partial enlarged view of area 23 of the apparatus of FIG. 22.

FIG. 24 shows a perspective view of the apparatus of FIG. 17 in an exploded state with the ruler in the process of being detached from the writing instrument.

FIG. 25 shows a side plan view of the apparatus of FIG. 24.

FIG. 26 shows a back plan section view 26-26 of the apparatus of FIG. 25.

### DETAILED DESCRIPTION OF THE INVENTION

The present invention is directed to a multipurpose writing instrument with a releasable ruler.

In one embodiment a ruler element is releasably engaged to a writing instrument assembly. The ruler element is made from a resilient material and may be comprised of an elongated semi-cylindrical tube, rotated at least 181 degrees about its longitudinal axis. The writing instrument assembly further includes a body element, an ink cartridge element and an end cap element. The body element is made from a rigid, substantially cylindrical tube having a tapered tip at one end and a recessed portion in its outer surface, with the recess being substantially complimentary in size and shape to the ruler element. The ink cartridge element is similar to those commonly known in field, being comprised of a cylindrical tube filled with ink and a writing tip that dispenses said ink. The writing instrument is assembled by inserting the ink cartridge element into the body element and then attaching the end cap element to the body element, such that the ink cartridge element is constrained within the body element by both the end cap element and the tapered tip portion of the body element. When the ruler element is attached to the writing instrument assembly, it substantially fills the recessed portion in the outer surface of the body element such that the outer surfaces of the ruler element and body element are substantially continuous.

In one preferred embodiment, the complimentary geometry of the ruler element and writing instrument assembly allow for retaining the ruler element on the writing instrument until it is intentionally removed. This is due to the fact that in order for the ruler element to be attached or detached from the writing instrument, it must undergo an elastic deformation that can only be achieved when a substantial force is applied to the ruler element in the appropriate direction.

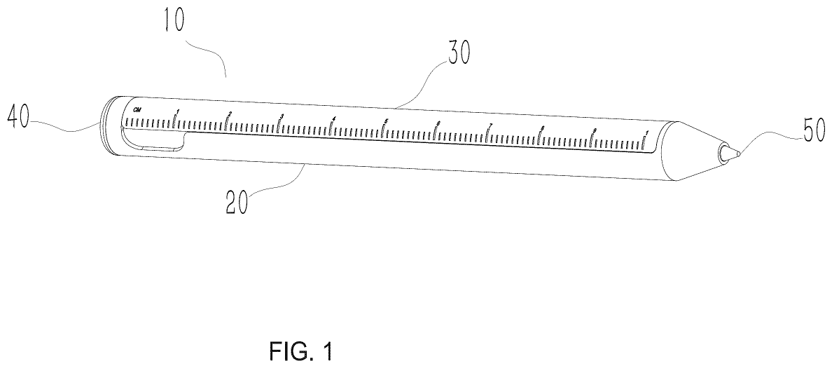

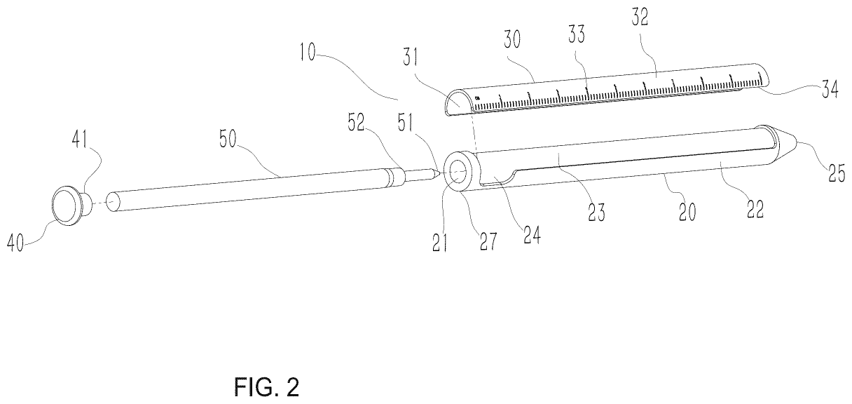

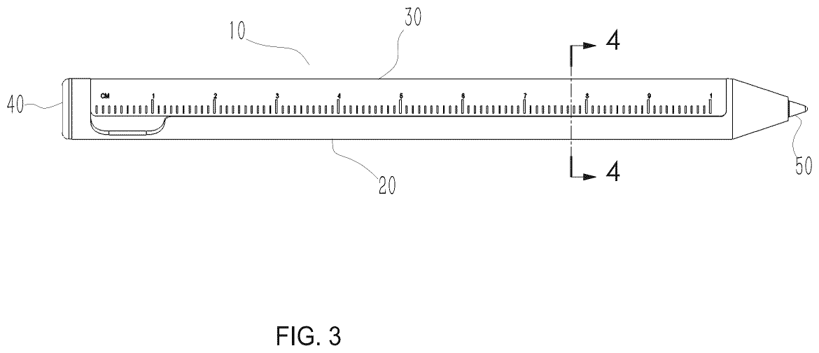

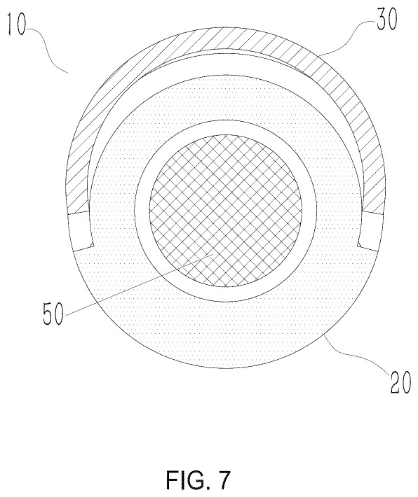

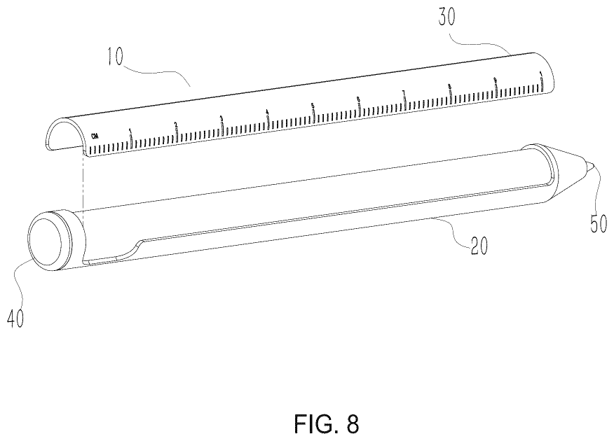

There is shown in FIGS. 1 through 8 an exemplary embodiment of a combined writing instrument and ruler apparatus 10. The apparatus 10 includes a body element 20, ruler element 30, end cap element 40 and ink cartridge element 50.

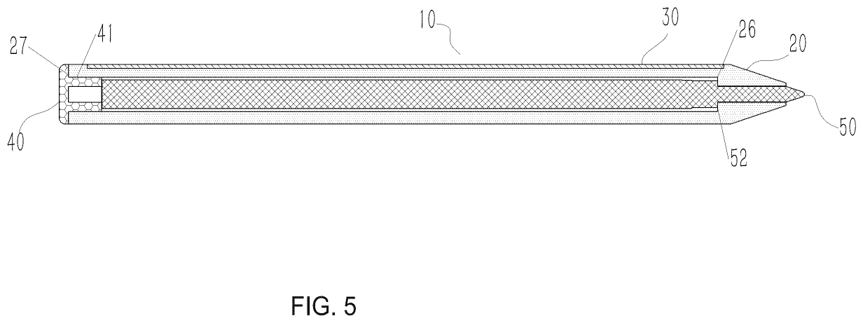

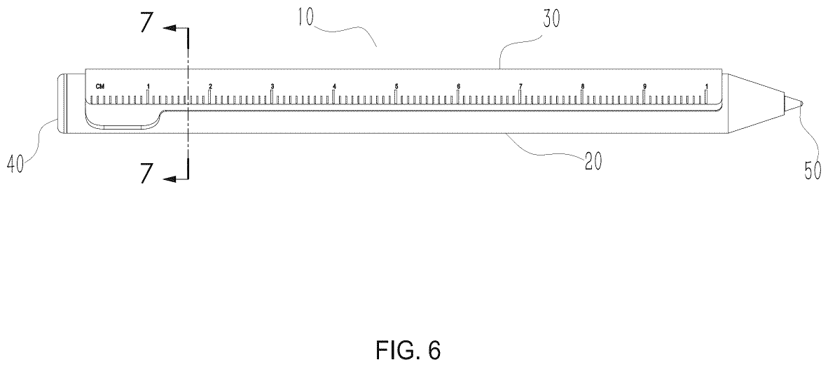

Ink cartridge element 50 is identical or similar to those commonly known in the field and is typically composed of an elongated tube having ink contained inside, a point portion 51 from which the ink is dispensed and a physical stop portion 52 that interfaces with a complimentary stop portion 26 of the body element 20 in order to accurately position the ink cartridge within the body element 20 when the apparatus is assembled, as best shown in FIG. 5.

End cap element 40 is similar to those commonly known in the field and includes an attachment portion 41 that may permanently or temporarily attach end cap element 40 to body element 20. The attachment portion 41 may include commonly known fastening features including, but not limited to, threads, snap features and press fit geometry. The end cap element 40 as shown in the embodiment of FIGS. 1 through 8 depicts press fit geometry in the attachment portion 41.

Body element 20 may be comprised of a substantially cylindrical tubular structure having an inner wall 21, outer wall 22, recessed portion 23, recessed finger grip portion 24, tip portion 25, stop portion 26 and end portion 27. The end portion 27 includes complimentary geometry to attachment portion 41 of end cap element 40, such that end cap element 40 may be permanently or temporarily attached to the end portion 27 of body element 20.

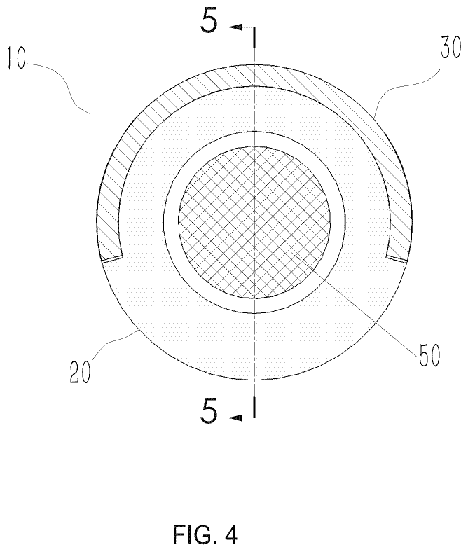

Ruler element 30 is made from a resilient material and shaped as an elongated semi-cylindrical tube rotated at least 181 degrees about its longitudinal axis, as can best be seen in FIG. 4. Ruler element 30 is comprised of an inner wall 31, outer wall 32, measurement markings 33 and edge portions 34. The shape and sizing of ruler element 30 is complimentary to the shape and size of the recessed portion 23 of body element 20, such that when ruler element 30 is attached to body element 20, the outer wall 32 of ruler element 30 is substantially continuous with the outer wall 22 of body element 20. The finger grip portion 24 of body element 20 is also recessed relative to outer wall 22 and is not filled by ruler element 30, such that the user is provided a space into which fingertips may be used to engage the edge portions 34 of ruler element 30 and apply a force to remove it from body element 20.

When ruler element 30 is removed from body element 20, it undergoes an clastic deformation that acts to temporarily increase the linear distance between edge portions 34 of ruler element 30 and thereby allow the ruler to be detached from body element 20. In the same way, ruler element 30 may be re-attached to body element 20 by pressing the edge portions 34 onto the recessed portion 23 of body element 20, thereby causing another elastic deformation of ruler element 30 that allows the ruler to snap back onto body element 20. This clastic deformation is best shown in FIG. 7. In some embodiments, the ruler element 30 is shaped such that, once the ruler element 30 is positioned onto the body element 20, the linear distance between the edge portions 34 is smaller than a maximum linear distance between two opposing sides of the recessed portion 23 at the widest portion of the recessed portion 23. The attachment of the ruler element 30 to the body element 20 does not require any additional parts, such as a screw cap, etc. The ruler element 30 is held on the body element 20 by the deformation force alone.

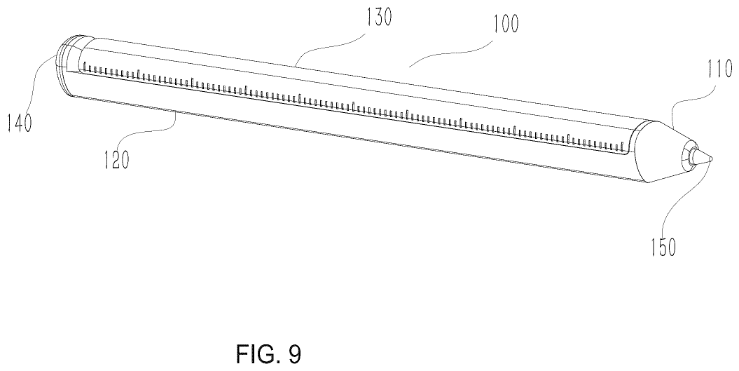

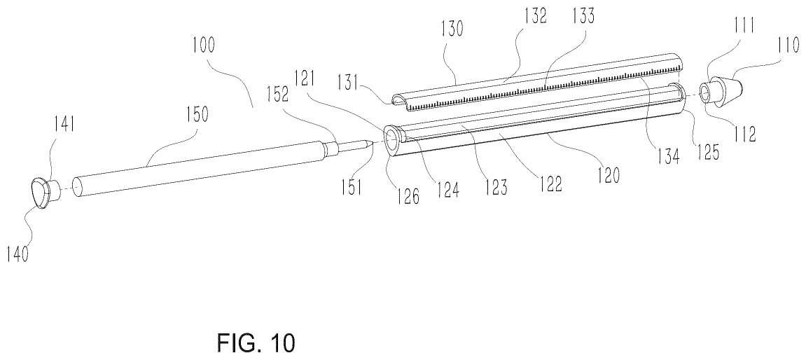

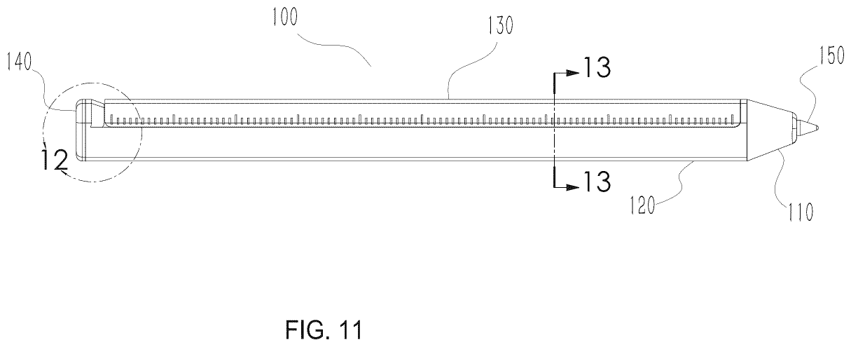

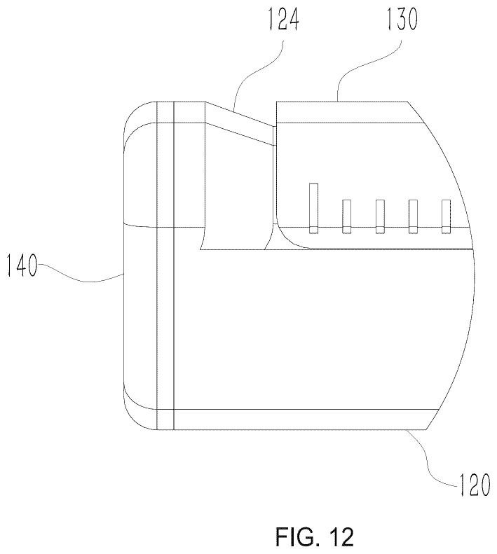

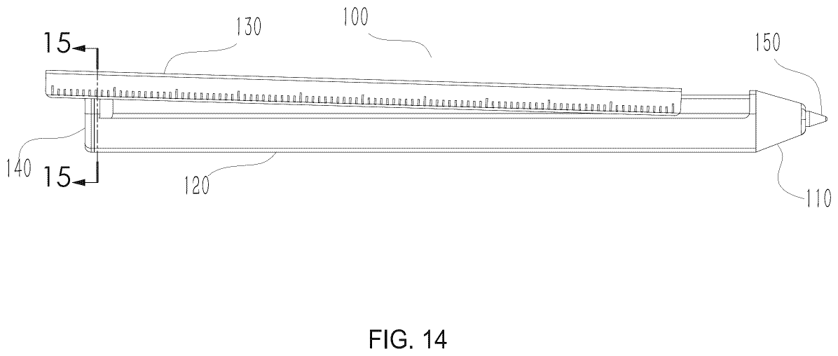

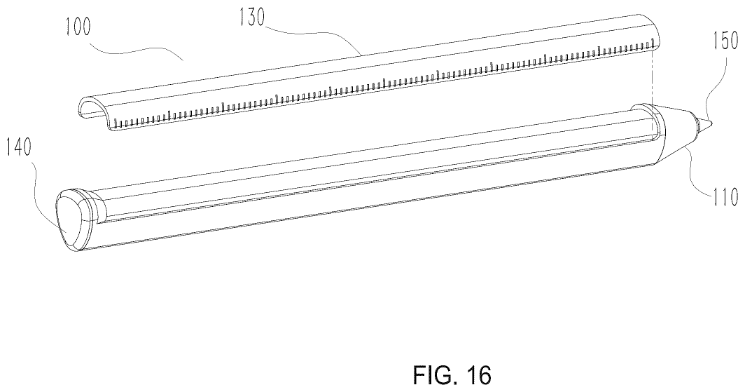

There is shown in FIGS. 9 through 16 another exemplary embodiment of a combined writing instrument and ruler apparatus 100. The apparatus 100 includes a tip element 110, body element 120, ruler element 130, end cap element 140 and ink cartridge element 150.

Ink cartridge element 150 is identical or similar to those commonly known in the field and is typically composed of an elongated tube having ink contained inside, a point portion 151 from which the ink is dispensed and a physical stop portion 152 that interfaces with a complimentary stop portion 112 of the tip element 110 in order to constrain the ink cartridge within the body element 120 when the apparatus is assembled.

End cap element 140 is similar to those commonly known to the field and includes an attachment portion 141 that provides a means to permanently or temporarily attach end cap element 140 to body element 120. The attachment portion 141 may include commonly known fastening features including, but not limited to, threads, snap features and press fit geometry. The end cap element 140 as shown in the apparatus of FIGS. 9 through 16 depicts press fit geometry in the attachment portion 141.

Tip element 110 is similar to those commonly known in the field and includes an attachment portion 111 that permanently or temporarily attaches tip element 110 to body element 120. The attachment portion 111 may include commonly known fastening features including, but not limited to, threads, snap features and press fit geometry. The tip element 110 as shown in FIGS. 9 through 16 depicts press fit geometry in the attachment portion 111. The tip element 110 also includes physical stop geometry 112 that acts to constrain the ink cartridge element 150 when the apparatus is fully assembled.

Body element 120 is comprised of a substantially triangular tubular structure with rounded corners, having an inner wall 121, outer wall 122, recessed portion 123, ramped or chamfered portion 124, tip portion 125, and end portion 126. The end portion 126 includes complimentary geometry to attachment portion 141 of end cap element 140, such that end cap element 140 may be permanently of temporarily attached to the end portion 126 of body element 120. The tip portion 125 includes complimentary geometry to attachment portion 111 of tip element 110, such that tip element 110 may be permanently or temporarily attached to the tip portion 125 of body element 120.

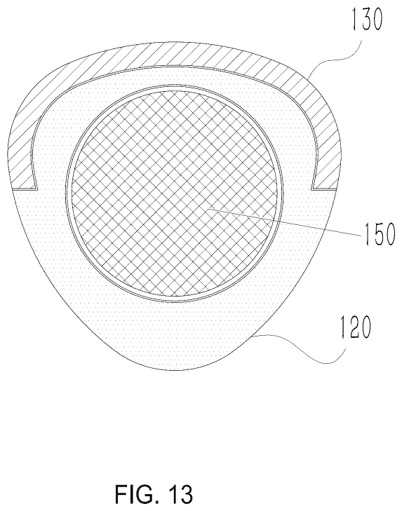

Ruler element 130 is made from a resilient material and shaped as an elongated semi-triangular tube with rounded corners, rotated at least 181 degrees about an inscribed circle along its longitudinal axis and symmetrical about the center point of one of the triangle edges, as can best be seen in FIG. 13. Ruler element 130 is comprised of an inner wall 131, outer wall 132, measurement markings 133 and edge portion 134. The shape and sizing of ruler element 130 is complimentary to the shape and size of the recessed portion 123 of body element 120, such that when ruler element 130 is attached to body element 120 the outer wall 132 of ruler element 130 is substantially continuous with the outer wall 122 of body element 120.

The ramped/chamfered portion 124 of body element 120 provides a leverage surface that may be used to engage the end of edge portion 134 of ruler element 130 in order to remove it from body element 120. This removal of ruler element 120 is accomplished when the user applies a force to outer surface 132 of ruler element 130 in the direction of ramped surface 124, thereby translating some of the force applied to the ruler into a direction away from body element 120 and acting to detach the ruler element 130 from body element 130. It is understood that a ramped/chamfered portion may also be provided at the opposite end of the body element 120 adjacent the tip element 110. The user may apply a force of the outer surface 132 of the ruler element 130 in the direction of the tip element 110, thereby translating some of the force into a direction away from the body element 120 to detach the ruler element 130 from the body element 130.

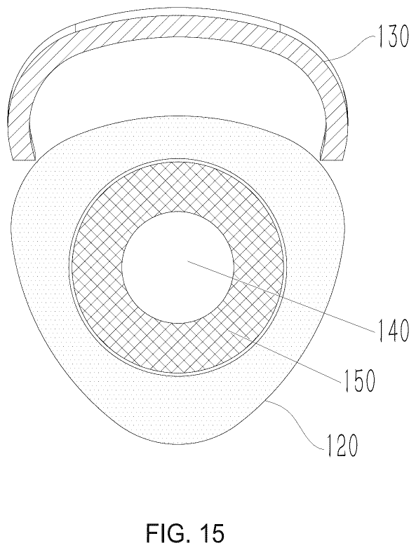

When ruler element 130 is removed from body element 120, it undergoes an clastic deformation that acts to temporarily increase the linear distance between the sides of edge portion 134 of ruler element 130 and thereby allow the ruler to be detached from body element 120. In the same way, ruler element 130 may be re-attached to body element 120 by pressing the sides of edge portion 134 onto the recessed portion 123 of body element 120, thereby causing elastic deformation of the edges that allows the ruler to snap back onto body element 120. This removal and attachment of ruler element 130 is best shown in FIG. 15.

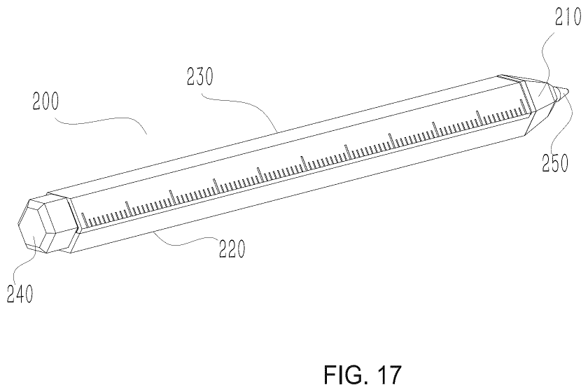

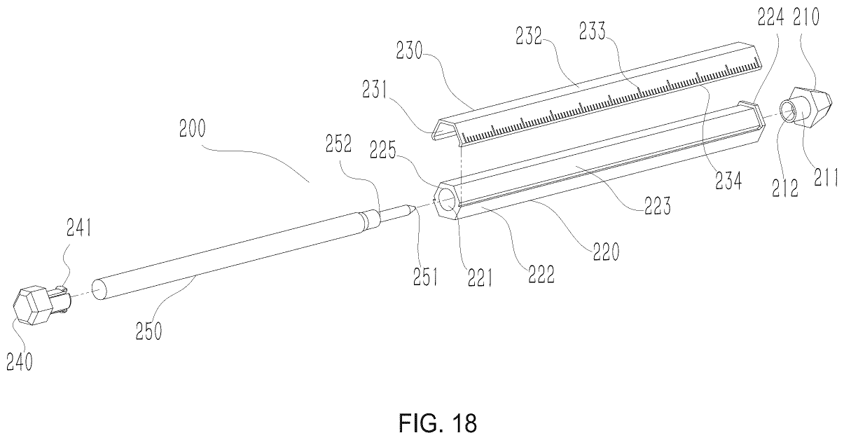

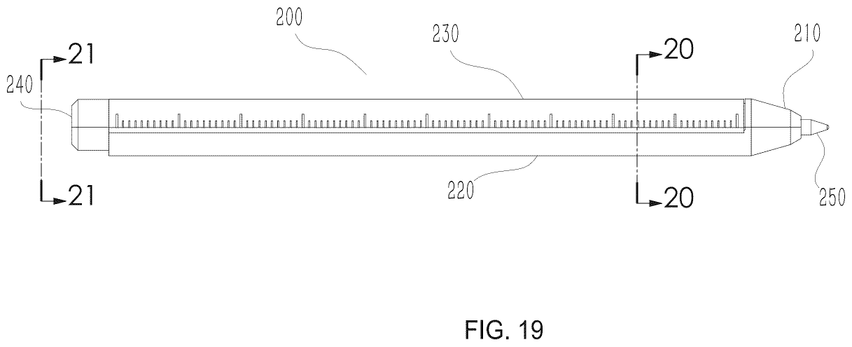

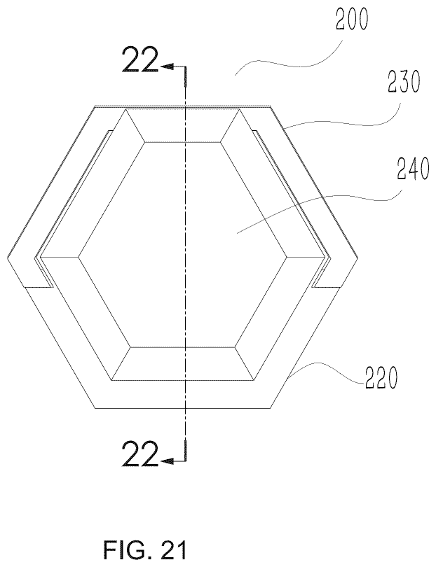

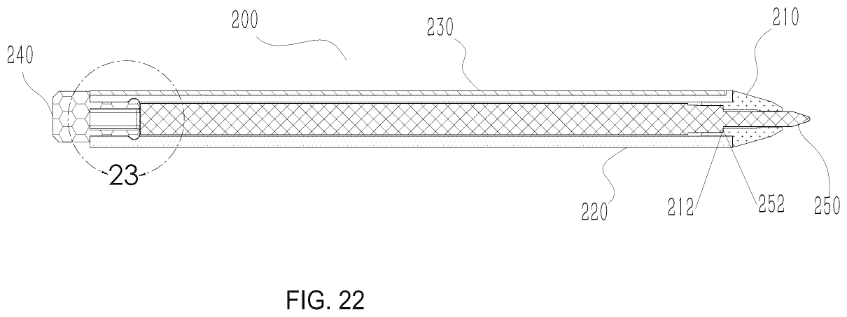

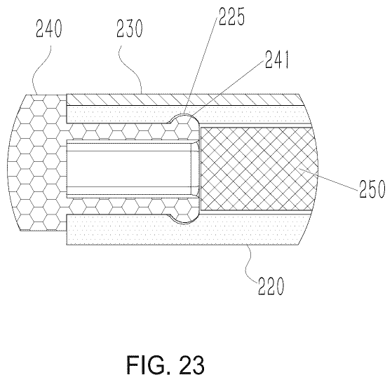

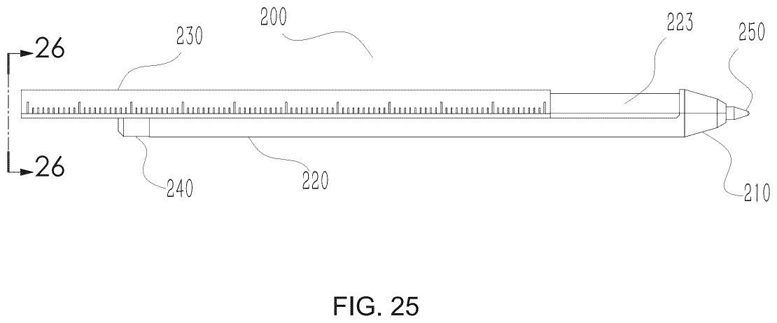

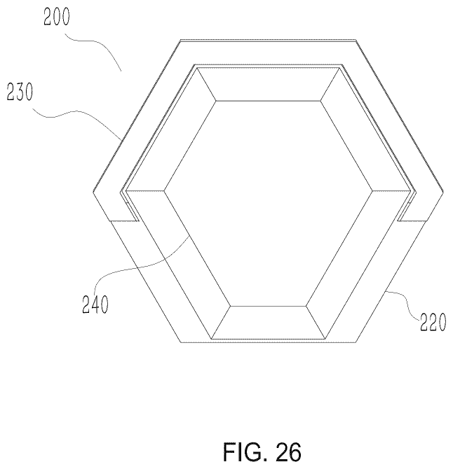

There is shown in FIGS. 17 through 26 another exemplary embodiment of a combined writing instrument and ruler apparatus 200. The apparatus 200 includes a tip element 210, body element 220, ruler element 230, end cap element 240 and ink cartridge element 250.

Ink cartridge element 250 is identical or similar to those commonly known in the field and is typically composed of an elongated tube having ink contained inside, a point portion 251 from which the ink is dispensed and a physical stop portion 252 that interfaces with a complimentary stop portion 212 of the tip element 210 in order to constrain the ink cartridge within the body element 220 when the apparatus is assembled.

End cap element 240 is similar to those commonly known in the field and includes an attachment portion 241 that rotatably attaches end cap element 240 to body element 220. The attachment portion 241 includes snap feature fastener element that allows the end cap 240 to rotate about the longitudinal axis of body element 220.

Tip element 210 is similar to those commonly known in the field and includes an attachment portion 211 that permanently or temporarily attaches tip element 210 to body element 220. The attachment portion 211 may include commonly known fastening features including, but not limited to, threads, snap features and press fit geometry. The tip element 210 as shown in FIGS. 17 through 26 depicts press fit geometry in the attachment portion 211. The tip element 210 also includes physical stop geometry 212 that acts to constrain the ink cartridge element 250 when the apparatus is fully assembled.

Body element 220 is comprised of a substantially hexagonal tubular structure, having an inner wall 221, outer wall 222, recessed portion 223, front portion 224 and end portion 225. The end portion 225 includes complimentary geometry to attachment portion 241 of end cap element 240, such that end cap element 240 may be attached to the end portion 225 of body element 220 in such a way that it is able to rotate about the longitudinal axis of body element 220. The front portion 224 includes complimentary geometry to attachment portion 211 of tip element 210, such that tip element 210 may be permanently or temporarily attached to the front portion 224 of body element 220.

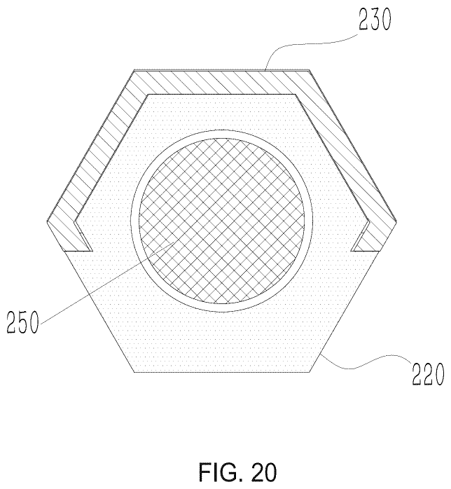

Ruler element 230 is made from a resilient or rigid material and shaped as an elongated semi-hexagonal tube, rotated at least 181 degrees about an inscribed circle along its longitudinal axis and symmetrical about the center point of one of the hexagon edges, as can best be seen in FIG. 20. Ruler element 230 is comprised of an inner wall 231, outer wall 232, measurement markings 233 and edge portion 234. The shape and sizing of ruler element 230 is complimentary to the shape and size of the recessed portion 223 of body element 220, such that when ruler element 230 is attached to body element 220 the outer wall 232 of ruler element 230 is substantially continuous with the outer wall 222 of body element 220.

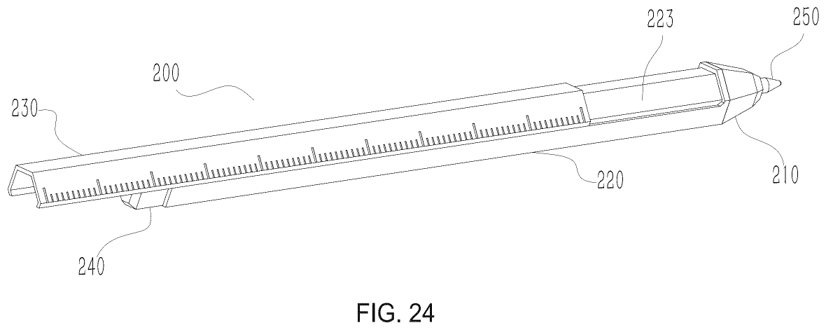

The end cap element 240 is shaped such that when it is rotated into a certain position relative to body element 220, as shown in FIGS. 24 through 26, the ruler element 230 may slide back and forth along the axial direction of body element 220, thereby allowing the ruler element 230 to be attached and detached from body element 220. When the end cap element is rotated into a different position, as shown in FIGS. 17 through 23, it acts to constrain ruler element 230 from sliding along the axis of body element 220, such that the ruler is fixedly attached to body element 220.

It should be noted variations and modifications can be made to the embodiments detailed in the description without departing from the principles of the present invention. Also, such variations and modifications are intended to be included herein within the scope of the present invention. The structures, materials, acts and equivalents of all means or step-plus function elements are intended to include any structure, materials or acts for performing their cited functions.

It should be emphasized that the above descriptions of the present invention are merely possible examples of implementations, merely set forth for a clear understanding of the principles of the invention. Any variations and modifications may be made to the above-described embodiments of the invention without departing from the principles of the invention. Such modifications include, but are not limited to, the application of the principles of the present invention to writing instruments such as pencils, mechanical pencils, click pens, stick pens, retractable pens, bolt action pens and other commonly known types of writing instruments. All such modifications and variations are intended to be included herein within the scope of the disclosure and present invention.

The present invention has been described in sufficient detail with a certain degree of particularity. The utilities thereof are appreciated by those skilled in the art. It is understood by those skilled in the art that the present disclosure of embodiments has been made by way of examples only and that numerous changes in the arrangement and combination or parts may be adopted without departing from the spirit and scope of the invention.

1. A multipurpose writing implement comprising:
a writing instrument having a body with an outer wall, and
a ruler releasably attached to the writing instrument, the ruler having a body with a longitudinal axis and an inner wall,
a recess formed in the outer wall of the body and configured to accommodate the ruler body,
wherein the inner wall of the ruler body substantially corresponds to a shape of the recess and an outer wall of the ruler body is substantially flush with the outer wall of the writing instrument body when the ruler is attached to the writing instrument.

2. The multipurpose writing implement according to claim 1, wherein the ruler body comprises a cross-section shape selected from circular, elliptical, and polygonal with sharp or rounded corners.

3. The multipurpose writing implement according to claim 1, wherein a portion of the recess does not accommodate the ruler body when the ruler is attached to the writing instrument, wherein the portion of the recess is configured to accommodate a user's finger to apply force to a portion of the ruler to disengage the ruler from the writing instrument.

4. The multipurpose writing implement according to claim 1, wherein a portion of the recess comprises a chamfered edge configured to engage a portion of the ruler when a longitudinal force is applied to the ruler relative to the writing instrument to detach the ruler from the writing instrument.

5. The multipurpose writing implement according to claim 1, wherein the ruler comprises a first longitudinal edge and a second longitudinal edge, the first and second longitudinal edges extending substantially parallel to the longitudinal axis of the ruler.

6. The multipurpose writing implement according to claim 5, wherein the first and second longitudinal edges are disposed at an angle of less than 180 degrees about the longitudinal axis relative to one another.

7. The multipurpose writing implement according to claim 5, wherein a linear distance between the first and second longitudinal edges is smaller than a maximum linear distance between two opposing sides of the recess at its widest portion when the ruler is positioned in the recess.

8. The multipurpose writing implement according to claim 1, wherein the ruler body comprises an elastic material configured to deform when pressed onto the body of the writing instrument.

9. The multipurpose writing implement according to claim 1, wherein the ruler is configured to be attached to the writing instrument body by deformation force alone.

10. A multipurpose writing implement comprising:
a writing instrument having a body with an outer wall; and
a ruler releasably attached to the writing instrument, the ruler having a body with a longitudinal axis and an inner wall substantially corresponding to a shape of at least a portion of the outer wall of the writing instrument;
wherein the ruler body comprises an elastic material configured to deform when pressed onto the body of the writing instrument such that the ruler is attached to the instrument body by deformation force.

11. The multipurpose writing implement according to claim 10, wherein the ruler body comprises a cross-section shape selected from circular, elliptical, and polygonal with sharp or rounded corners.

12. The multipurpose writing implement according to claim 10, wherein the ruler comprises a first longitudinal edge and a second longitudinal edge, the first and second longitudinal edges extending substantially parallel to the longitudinal axis of the ruler and disposed at an angle of less than 180 degrees about the longitudinal axis relative to one another.

13. The multipurpose writing implement according to claim 10, wherein the writing instrument body comprises a recess formed in the outer wall of the body and configured to accommodate the ruler body, wherein an outer wall of the ruler body is substantially flush with the outer wall of the writing instrument body when the ruler is attached to the writing instrument.

14. The multipurpose writing implement according to claim 13, wherein the ruler comprises a first longitudinal edge and a second longitudinal edge, the first and second longitudinal edges extending substantially parallel to the longitudinal axis of the ruler, and wherein a linear distance between the first and second longitudinal edges is smaller than a maximum linear distance between two opposing sides of the recess at its widest portion when the ruler is positioned in the recess.

15. The multipurpose writing implement according to claim 13, wherein a portion of the recess does not accommodate the ruler body when the ruler is attached to the writing instrument, wherein the portion of the recess is configured to accommodate a user's finger to apply force to a portion of the ruler to disengage the ruler from the writing instrument.

16. The multipurpose writing implement according to claim 13, wherein a portion of the recess comprises a chamfered edge configured to engage a portion of the ruler when a longitudinal force is applied to the ruler relative to the writing instrument to detach the ruler from the writing instrument.

17. The multipurpose writing implement according to claim 10, wherein the ruler is configured to be attached to the writing instrument body by deformation force alone.
